(19) United States
(12) Patent Application Publication
(10) Pub. No.: US 2018/0195028 A1
(43) Pub. Date: Jul. 12, 2018

(54) LAUNDRY SCENT PARTICLES

(71) Applicant: The Procter & Gamble Company, Cincinnati, OH (US)

(72) Inventor: Richard Timothy HARTSHORN, Lawrenceburg, IN (US)

(21) Appl. No.: 15/401,508

(22) Filed: Jan. 9, 2017

(51) Int. Cl. C11D 3/50; C11D 3/20; C11D 11/00; C11D 3/37; C11D 3/12

(52) U.S. Cl. CPC C11D 3/505; C11D 3/2068; C11D 3/50; C11D 11/0017; B65D 85/70; C11D 3/1253; C11D 3/2093; C11D 3/2089; C11D 3/3753

(57) ABSTRACT

A packaged particulate composition having polyethylene glycol, perfume, a material selected from the group consisting of a polyalkylene polymer, a polyethylene glycol fatty acid ester, a polyethylene glycol fatty alcohol ether, and combinations thereof, and occlusions of gas. The particulate can be formed by rotoforming.

### FIELD OF THE INVENTION

Providing scent to laundry.

### BACKGROUND OF THE INVENTION

There are a variety of packaged compositions for treating laundry. Perfumed particles are becoming increasingly popular as a laundry scent additive. The perfumed particles can be used to impart scent to the articles being washed. Further, the perfume can provide for a pleasant experience for the consumer when he transfers the load of wet laundry from the washing machine to the dryer.

Some perfumed particles contain encapsulates that contain perfume within a capsule wall. The perfume encapsulates can become entrapped or deposited on the articles being washed. When the consumer wears or uses the articles being washed, the perfume encapsulates can rupture and release a pleasant amount of perfume that provides pleasure to the consumer.

Users of particulate laundry scent particles are typically instructed to dose the laundry scent additive to an empty wash basin or drum. This is to provide for the maximum amount of time during the wash for the particles to dissolve. Prior to the agitation cycle, the particles remain trapped at the bottom of the wash basin or drum and may dissolve in that local. This might result in an uneven distribution of the perfume contained in the laundry scent particles to the clothing being washed. With these limitations in mind, there is a continuing unaddressed need for laundry scent particles that are able to provide for distribution of perfume throughout the load of laundry contained in the wash basin or drum.

### SUMMARY OF THE INVENTION

A packaged composition comprising a plurality of particles (90), wherein said particles comprise: polyethylene glycol; perfume; and a material selected from the group consisting of: a polyalkylene polymer of formula H—(C₂H₄O)ₓ—(CH(CH₃)CH₂O)_{y}—(C₂H₄O)_{z}—OH wherein x is from about 50 to about 300, y is from about 20 to about 100, and z is from about 10 to about 200; a polyethylene glycol fatty acid ester of formula (C₂H₄O)_{q}—C(O)O—(CH₂)ᵣ—CH₃ wherein q is from about 20 to about 200 and r is from about 10 to about 30; a polyethylene glycol fatty alcohol ether of formula HO—(C₂H₄O)ₛ—(CH₂)ₜ)—CH₃ wherein s is from about 30 to about 250 and t is from about 10 to about 30; and mixtures thereof; wherein each of said particles has a density from about 0.5 g/cm³ to less than 1 g/cm³; wherein each of said particles has a mass from about 0.1 mg to about 5 g; and wherein each of said particles has a maximum dimension of less than about 10 mm.

A process of making particles comprising the steps of: providing a molten carrier material comprising polyethylene glycol and a material selected from the group consisting of: a polyalkylene polymer of formula H—(C₂H₄O)ₓ—(CH(CH₃)CH₂O)_{y}—(C₂H₄O)_{z}—OH wherein x is from about 50 to about 300, y is from about 20 to about 100, and z is from about 10 to about 200; a polyethylene glycol fatty acid ester of formula (C₂H₄O)_{q}—C(O)O—(CH₂)ᵣ—CH₃ wherein q is from about 20 to about 200 and r is from about 10 to about 30; a polyethylene glycol fatty alcohol ether of formula HO—(C₂H₄O)ₛ—(CH₂)ₜ)—CH₃ wherein s is from about 30 to about 250 and t is from about 10 to about 30; and mixtures thereof adding perfume to the molten carrier material; entraining a gas into the carrier material; and passing the carrier material carrying the perfume and the gas through apertures and depositing the carrier material carrying the perfume and the gas onto a conveyor to form the particles.

### BRIEF DESCRIPTION OF THE DRAWINGS

FIG. 1 is a profile view of a particle.

FIG. 2 is a packaged composition comprising a plurality of particles.

### DETAILED DESCRIPTION OF THE INVENTION

The particles can comprise polyethylene glycol, perfume, and a material selected from the group consisting of: a polyalkylene polymer of formula H—(C₂H₄O)ₓ—(CH(CH₃)CH₂O)_{y}—(C₂H₄O)_{z}—OH wherein x is from about 50 to about 300, y is from about 20 to about 100, and z is from about 10 to about 200; a polyethylene glycol fatty acid ester of formula (C₂H₄O)_{q}—C(O)O—(CH₂)ᵣ—CH₃ wherein q is from about 20 to about 200 and r is from about 10 to about 30; a polyethylene glycol fatty alcohol ether of formula HO—(C₂H₄O)ₛ—(CH₂)ₜ)—CH₃ wherein s is from about 30 to about 250 and t is from about 10 to about 30; and mixtures thereof. The polyalkylene polymer of formula H—(C₂H₄O)ₓ—(CH(CH₃)CH₂O)_{y}—(C₂H₄O)_{z}—OH wherein x is from about 50 to about 300, y is from about 20 to about 100, and z is from about 10 to about 200, can be a block copolymer or random copolymer.

The particles can comprise: polyethylene glycol; a polyalkylene polymer of formula H—(C₂H₄O)ₓ—(CH(CH₃)CH₂O)_{y}—(C₂H₄O)_{z}—OH wherein x is from about 50 to about 300; y is from about 20 to about 100, and z is from about 10 to about 200; a polyethylene glycol fatty acid ester of formula (C₂H₄O)_{q}—C(O)O—(CH₂)ᵣ—CH₃ wherein q is from about 20 to about 200 and r is from about 10 to about 30; a polyethylene glycol fatty alcohol ether of formula HO—(C₂H₄O)ₛ—(CH₂)ₜ)—CH₃ wherein s is from about 30 to about 250 and t is from about 10 to about 30; and perfume.

The particles can comprise from about 15% to about 40% by weight of the particles of polyalkylene polymer of formula H—(C₂H₄O)ₓ—(CH(CH₃)CH₂O)_{y}—(C₂H₄O)_{z}—OH wherein x is from about 50 to about 300; y is from about 20 to about 100, and z is from about 10 to about 200.

The particles can comprise from about 1% to about 20% by weight of the particles polyethylene glycol fatty acid ester of formula (C₂H₄O)_{q}—C(O)O—(CH₂)ᵣ—CH₃ wherein q is from about 20 to about 200 and r is from about 10 to about 30.

The particles can comprise from about 1% to about 10% by weight of the particles of polyethylene glycol fatty alcohol ether of formula HO—(C₂H₄O)ₛ—(CH₂)ₜ)—CH₃ wherein s is from about 30 to about 250 and t is from about 10 to about 30.

The particles can comprise from about 20% by weight to about 99% by weight of the particles of polyethylene glycol. The particles can comprise from about 40% by weight to about 99% by weight of the particles of polyethylene glycol. The polyethylene glycol can have a weight average molecular weight from about 2000 to about 13000. Polyethylene glycol (PEG) has a relatively low cost, may be formed into many different shapes and sizes, minimizes unencapsulated perfume diffusion, and dissolves well in water. PEG comes in various weight average molecular weights. A suitable weight average molecular weight range of PEG includes from about 2,000 to about 13,000, from about 4,000 to about 12,000, alternatively from about 5,000 to about 11,000, alternatively from about 6,000 to about 10,000, alternatively from about 7,000 to about 9,000, alternatively combinations thereof. PEG is available from BASF, for example PLURIOL E 8000.

The particles can comprise more than about 40% by weight of the particles of PEG. The particles can comprise more than about 50% by weight of the particles of PEG. The particles can comprise more than about 60% by weight of the particles of PEG. The particles may comprise from about 65% to about 99% by weight of the composition of PEG. The particles may comprise from about 40% to about 99% by weight of the composition of PEG.

Alternatively, the particles can comprise from about 40% to about 90%, alternatively from about 45% to about 75%, alternatively from about 50% to about 70%, alternatively combinations thereof and any whole percentages or ranges of whole percentages within any of the aforementioned ranges, of PEG by weight of the particles.

Depending on the application, the particles can comprise from about 0.5% to about 5% by weight of the particles of a balancing agent selected from the group consisting of glycerin, polypropylene glycol, isopropyl myristate, dipropylene glycol, 1,2-propanediol, and PEG having a weight average molecular weight less than 2,000, and mixtures thereof.

The particles can comprise an antioxidant. The antioxidant can help to promote stability of the color and or odor of the particles over time between production and use. The particles can comprise from about 0.01% to about 1% by weight antioxidant. The particles can comprise from about 0.001% to about 2% by weight antioxidant. The particles can comprise from about 0.01% to about 0.1% by weight antioxidant. The antioxidant can be butylated hydroxytoluene.

In addition to the PEG, the particles can further comprise 0.1% to about 20% by weight perfume. The perfume can be unencapsulated perfume, encapsulated perfume, perfume provided by a perfume delivery technology, or a perfume provided in some other manner. Perfumes are generally described in U.S. Pat. No. 7,186,680 at column 10, line 56, to column 25, line 22. The particles can comprise unencapsulated perfume and are essentially free of perfume carriers, such as a perfume encapsulates. The particles can comprise perfume carrier materials (and perfume contained therein). Examples of perfume carrier materials are described in U.S. Pat. No. 7,186,680, column 25, line 23, to column 31, line 7. Specific examples of perfume carrier materials may include cyclodextrin and zeolites.

The particles can comprise about 0.1% to about 20%, alternatively about 1% to about 15%, alternatively 2% to about 10%, alternatively combinations thereof and any whole percentages within any of the aforementioned ranges, of perfume by weight of the particles. The particles can comprise from about 0.1% by weight to about 6% by weight of the particles of perfume. The perfume can be unencapsulated perfume and or encapsulated perfume.

The particles can be free or substantially free of a perfume carrier. The particles may comprise about 0.1% to about 20%, alternatively about 1% to about 15%, alternatively 2% to about 10%, alternatively combinations thereof and any whole percentages within any of the aforementioned ranges, of unencapsulated perfume by weight of the particles.

The particles can comprise unencapsulated perfume and encapsulated perfume. The particles may comprise about 0.1% to about 20%, alternatively about 1% to about 15%, alternatively from about 2% to about 10%, alternatively combinations thereof and any whole percentages or ranges of whole percentages within any of the aforementioned ranges, of the unencapsulated perfume by weight of particles. Such levels of unencapsulated perfume can be appropriate for any of the particles disclosed herein that have unencapsulated perfume.

The particles can comprise unencapsulated perfume and a perfume encapsulate but be free or essentially free of other perfume carriers. The particles can comprise unencapsulated perfume and encapsulated perfume and be free of other perfume carriers.

The particles can comprise encapsulated perfume. Encapsulated perfume can be provided as plurality of perfume encapsulates. A perfume encapsulate is perfume oil enclosed within a shell. The shell can have an average shell thickness less than the maximum dimension of the perfume core. The perfume encapsulates can be friable perfume encapsulates. The perfume encapsulates can be moisture activated perfume encapsulates.

The perfume encapsulates can comprise a melamine/formaldehyde shell. Perfume encapsulates may be obtained from Appleton, Quest International, or International Flavor & Fragrances, or other suitable source. The perfume encapsulate shell can be coated with polymer to enhance the ability of the perfume encapsulate to adhere to fabric. This can be desirable if the particles are designed to be a fabric treatment composition. The perfume encapsulates can be those described in U.S. Patent Pub. 2008/0305982.

The particles can comprise about 0.1% to about 20%, alternatively about 1% to about 15%, alternatively 2% to about 10%, alternatively combinations thereof and any whole percentages within any of the aforementioned ranges, of encapsulated perfume by weight of the particles.

The particles can comprise perfume encapsulates but be free of or essentially free of unencapsulated perfume. The particles may comprise about 0.1% to about 20%, alternatively about 1% to about 15%, alternatively about 2% to about 10%, alternatively combinations thereof and any whole percentages within any of the aforementioned ranges, of encapsulated perfume by weight of the particles.

The particles can be prepared by providing molten carrier material into a batch mixer 10. The carrier material can comprise: polyethylene glycol and a material selected from the group consisting of: a polyalkylene polymer of formula H—(C₂H₄O)ₓ—(CH(CH₃)CH₂O)_{y}—(C₂H₄O)_{z}—OH wherein x is from about 50 to about 300, y is from about 20 to about 100, and z is from about 10 to about 200; a polyethylene glycol fatty acid ester of formula (C₂H₄O)_{q}—C(O)O—(CH₂)ᵣ—CH₃ wherein q is from about 20 to about 200 and r is from about 10 to about 30; a polyethylene glycol fatty alcohol ether of formula HO—(C₂H₄O)ₛ—(CH₂)ₜ)—CH₃ wherein s is from about 30 to about 250 and t is from about 10 to about 30; and mixtures thereof. The batch mixer 10 can be heated so as to help prepare the carrier material to the desired temperature. Perfume is added to the molten carrier material. Dye, if present, can be added to the batch mixer 10. Other adjunct materials can be added to the carrier material if desired. The precursor material to the particles can optionally be prepared by in-line mixing or other known approaches for mixing materials.

Optionally the particles can comprise clay. The clay can be bentonite. The clay can be provided as a perfume carrier in which the clay carries unencapsulated perfume. For particles that include clay, a greater volume of occlusions of gas may be practical for providing the desired density of the particles. This is because clays tend to have a specific gravity of from about 2.7 to 2.8. The particles can comprise from about 1% to about 40% by weight of the particles clay. The particles can comprise from about 20% to about 35% by weight of the particles clay.

If dye is employed, the precursor material and particles may comprise dye. The precursor material, and thereby particles, may comprise less than about 0.1%, alternatively about 0.001% to about 0.1%, alternatively about 0.01% to about 0.02%, alternatively combinations thereof and any hundredths of percent or ranges of hundredths of percent within any of the aforementioned ranges, of dye by weight of the precursor material or particles. Examples of suitable dyes include, but are not limited to, LIQUITINT PINK AM, AQUA AS CYAN 15, and VIOLET FL, available from Milliken Chemical.

A gas can be entrained into the molten carrier material. Together, the carrier material, perfume, and entrained gas can be passed through apertures and deposited on a conveyor to form particles. The apertures can have an open area of from about 0.5 mm² to about 20 mm². The apertures can have a diameter of about 2 mm. For instance the carrier material, perfume, and entrained gas can be formed into particles by rotoforming. For example using a rotoformer such as a SANDVIK ROTOFORM 3000.

The particles may have a variety of shapes. The particles may be formed into different shapes include tablets, pills, spheres, and the like. A particle can have a shape selected from the group consisting of spherical, hemispherical, compressed hemispherical, lentil shaped, and oblong. Lentil shaped refers to the shape of a lentil bean. Compressed hemispherical refers to a shape corresponding to a hemisphere that is at least partially flattened such that the curvature of the curved surface is less, on average, than the curvature of a hemisphere having the same radius. A compressed hemispherical particle can have a ratio of height to maximum based dimension of from about 0.01 to about 0.4, alternatively from about 0.1 to about 0.4, alternatively from about 0.2 to about 0.3. Oblong shaped refers to a shape having a maximum dimension and a maximum secondary dimension orthogonal to the maximum dimension, wherein the ratio of maximum dimension to the maximum secondary dimension is greater than about 1.2. An oblong shape can have a ratio of maximum base dimension to maximum minor base dimension greater than about 1.5. An oblong shape can have a ratio of maximum base dimension to maximum minor base dimension greater than about 2. Oblong shaped particles can have a maximum base dimension from about 2 mm to about 6 mm, a maximum minor base dimension of from about 2 mm to about 6 mm.

Individual particles can have a mass from about 0.1 mg to about 5 g, alternatively from about 10 mg to about 1 g, alternatively from about 10 mg to about 500 mg, alternatively from about 10 mg to about 250 mg, alternatively from about 0.95 mg to about 125 mg, alternatively combinations thereof and any whole numbers or ranges of whole numbers of mg within any of the aforementioned ranges. In a plurality of particles, individual particles can have a shape selected from the group consisting of spherical, hemispherical, compressed hemispherical, lentil shaped, and oblong.

An individual particle may have a volume from about 0.003 cm³ to about 0.15 cm³. The particles perpendicular dimensions x, y, and z can be such that x is from about 1 to about 2 mm, y is from about 2 mm to about 8 mm, and z is from about 2 mm to about 8 mm. The particles may be lenticular, disk shaped, or any other shape.

A number of particles may collectively comprise a dose for dosing to a laundry washing machine or laundry wash basin. A single dose of the particles may comprise from about 1 g to about 30 g. A single dose of the particles may comprise from about 5 g to about 30 g, alternatively from about 10 g to about 30 g, alternatively from about 14 g to about 20 g, alternatively from about 15 g to about 19 g, alternatively from about 18 g to about 19 g, alternatively combinations thereof and any whole numbers of grams or ranges of whole numbers of grams within any of the aforementioned ranges. The individual particles forming the dose of particles that can make up the dose can have a mass from about 0.95 mg to about 2 g. The plurality of particles can be made up of particles having different size, shape, and/or mass. The particles in a dose can have a maximum dimension less than about 1 centimeter.

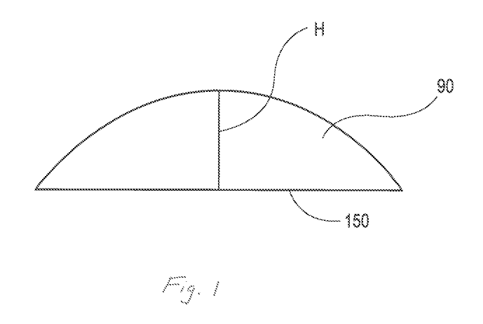

A particle 90 that can be manufactured as provided herein is shown in FIG. 1. FIG. 1 is a profile view of a single particle 90. The particle 90 can have a substantially flat base 150 and a height H. The height H of a particle 90 is measured as the maximum extent of the particle 90 in a direction orthogonal to the substantially flat base 150. The height H can be measured conveniently using image analysis software to analyze a profile view of the particle 90.

Particles 90 that have gas entrained therein are comprised of gas inclusions and solid and or liquid materials. Since the particles 90 have gas entrained therein, the particles 90 have a density that is less than the density of the constitutive solid and or liquid materials forming the particle 90. For instance if the particle 90 is formed of a constitutive material having a density of 1 g/cm³, and the particle 90 is 10% by volume air, the density of the particle 90 is 0.90 g/cm³.

For particles 90 that are used as a laundry scent additive, it can be practical that the particles 90 float in the wash solution of a laundry washing machine. Providing particles 90 that float in a the wash solution of a washing machine can provide the benefit of enabling the particles to move from the bottom of the wash basin or drum where such particles 90 might be dispensed upwards by floating towards the top of the wash basin or drum. As the particles 90 float upwardly through the wash, the perfume carried by the particles 90 can be deposited onto the fabric in the load of wash. This might provide for more uniform mass transfer of the perfume from the particles 90 to the fabric of the wash load as compared to particles 90 that tend to rest on the bottom of the wash basin or drum as they dissolve.

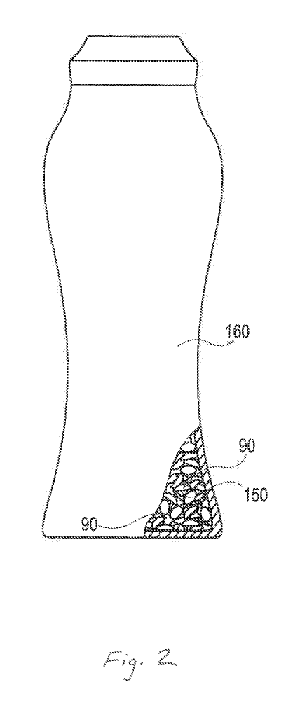

The particles 90 can be packaged together as a packaged composition 160 comprising a plurality of particles 90, as shown in FIG. 2. The particles can comprise a carrier as described previously, perfume, and occlusions of gas. Without being bound by theory, spherical occlusions of gas might provide for improved strength of particles 90 over non-spherical occlusions of gas.

Each of the particles 90 can have a density from about 0.3 g/cm³ to less than 1 g/cm³. Each of the particles 90 can have a density less than about 0.95 g/cm³. Since the density of a typical washing solution is about 1 g/cm³, it can be desirable to provide particles 90 that have a density from about 0.3 g/cm³ to about 0.96 g/cm³. Each of the particles 90 can have a density from about 0.5 g/cm³ to less than 1 g/cm³. By having the density less than about 0.96 g/cm³, it is thought that with the typical manufacturing variability for particle making processes, that nearly all of the particles 90 produced will have a density less than about 1 g/cm³. Having nearly all of the particles 90 have a density less than about 1 g/cm³ can be desirable for providing for particles 90 that will tend to float in a wash liquor. The mass transfer of perfume from the particles 90 to the fabric being washed may be greater for particles 90 that float as compared to particles 90 that remain at the bottom of the wash basin or drum.

Each of the particles 90 can have a mass from about 0.1 mg to about 5 g. Particles 90 can have a maximum dimension of less than about 20 mm. Particles 90 can have a maximum dimension of less than about 10 mm. Particles 90 having such a mass and maximum dimension are thought to be readily dissolvable in solutions such a wash solutions used in laundering clothing.

Each of the particles 90 can have a volume and the occlusions of gas within the particles 90 can comprise from about 0.5% to about 50% by volume of the particle 90, or even from about 1% to about 20% by volume of the particle, or even from about 2% to about 15% by volume of the particle, or even from about 4% to about 12% by volume of the particle. Without being bound by theory, it is thought that if the volume of the occlusions of gas is too great, the particles 90 may not be sufficiently strong to be packaged, shipped, stored, and used without breaking apart in an undesirable manner.

The occlusions can have an effective diameter from about 1 micron to about 2000 microns, or even from about 5 microns to about 1000 microns, or even from about 5 microns to about 200 microns, or even from about 25 to about 50 microns. In general, it is thought that smaller occlusions of gas are more desirable than larger occlusions of gas. If the effective diameter of the occlusions of gas are too large, it is thought that the particles might not be sufficiently strong to be to be packaged, shipped, stored, and used without breaking apart in an undesirable manner. The effective diameter is diameter of a sphere having the same volume as the occlusion of gas. The occlusions of gas can be spherical occlusions of gas.

Particles 90 can be produced as follows. A 50 kg batch of precursor material can be prepared in a mixer. The carrier material can comprise: 30% by weight of the precursor material polyethylene glycol; 17% by weight of the precursor material polyalkylene polymer of formula H—(C₂H₄O)ₓ—(CH(CH₃)CH₂O)_{y}—(C₂H₄O)_{z}—OH wherein x is from about 50 to about 300; y is from about 20 to about 100, and z is from about 10 to about 200; 9% by weight of the precursor material polyethylene glycol fatty acid ester of formula (C₂H₄O)_{q}—C(O)O—(CH₂)ᵣ—CH₃ wherein q is from about 20 to about 200 and r is from about 10 to about 30; 3% by weight of the precursor material polyethylene glycol fatty alcohol ether of formula HO—(C₂H₄O)ₛ—(CH₂)ₜ)—CH₃ wherein s is from about 30 to about 250 and t is from about 10 to about 30; and 28.36% by weight of the precursor material bentonite clay.

The carrier material can be added to a jacketed mixer held at 70° C. and agitated with a pitch blade agitator at 125 rpm. Butylated hydroxytoluene can be added to the mixer at a level of 0.01% by weight of the precursor material. Dipropylene glycol can be added to the mixer at a level of 1.08% by weight of the precursor material. A water based slurry of perfume encapsulates can be added to the mixer at a level of 4.04% by weight of the precursor material. Unencapsulated perfume can be added to the mixer at a level of 7.50% by weight of the precursor material. Dye can be added to the mixer at a level of 0.0095% by weight of the precursor material. The carrier can account for 87.36% by weight of the precursor material. The precursor material can be mixed for 30 minutes.

The precursor material can be formed into particles 90 on a SANDVIK ROTOFORM 3000 having a 750 mm wide 10 m long belt. The cylinder can have 2 mm diameter apertures set at a 10 mm pitch in the cross machine direction and 9.35 mm pitch in the machine direction. The cylinder can be set at approximately 3 mm above the belt. The belt speed and rotational speed of the cylinder can be set at 10 m/min.

After mixing the precursor material, the precursor material can be pumped at a constant 3.1 kg/min rate from the mixer through a plate and frame heat exchanger set to control the outlet temperature to 50° C.

Air or another gas can be entrained in the precursor material at a level of about 0.5% to about 50% by volume. The precursor material having air or another gas entrained therein can be passed through a Quadro Z1 mill with medium rotor/stator elements. After milling, the precursor material can optionally be passed through a Kenics 1.905 cm KMS 6 static mixer 50 installed 91.44 cm upstream of the stator.

Table 1 lists nonlimiting example formulations of particles 90 that could be made.

TABLE 1
Potential formulations for particles.

| % Wt | F1 | F2 | F3 | F4 | F5 | F6 |
|---|---|---|---|---|---|---|
| PEG 8000 | 32.8 | 20.8 | 27.9 | 23.9 | 60.5 | 51 |
| Polyalkylene polymer | 15 | 18 | 21 | 24 | 18 | 21 |
| of formula H— | | | | | | |
| (C₂H₄O)ₓ— | | | | | | |
| (CH(CH₃)CH₂O)_{y}— | | | | | | |
| (C₂H₄O)_{z}—OH wherein | | | | | | |
| ₓ is from about 50 to | | | | | | |
| about 300; _{y} is from | | | | | | |
| about 20 to about 100, | | | | | | |
| and _{z} is from about 10 | | | | | | |
| to about 200 | | | | | | |
| Polyethylene glycol | 8 | 10 | 12 | 10 | 12 | 8 |
| fatty acid ester of | | | | | | |
| formula (C₂H₄O)_{q}— | | | | | | |
| C(O)O—(CH₂)ᵣ—CH₃ | | | | | | |
| wherein _{q} is from | | | | | | |
| about 20 to about 200 | | | | | | |
| and ᵣ is from about 10 | | | | | | |
| to about 30 | | | | | | |
| Polyethylene glycol | 2 | 4 | 6 | 6 | 5 | 2 |
| fatty alcohol ether of | | | | | | |
| formula HO—(C₂H₄O)ₛ— | | | | | | |
| (CH₂)ₜ)—CH₃ wherein ₛ | | | | | | |
| is from about 30 to | | | | | | |
| about 250 and ₜ is from | | | | | | |
| about 10 to about 30 | | | | | | |
| Bentonite Clay | 25 | 30 | 20 | 25 | — | — |
| BHT | 0.0135 | 0.0135 | 0.0173 | 0.0167 | — | 0.0213 |
| Perfume encapsulate | 1.28 | 1.28 | 0.815 | 3.80 | 1.62 | — |
| Neat Perfume Oil | 6.65 | 6.65 | 5.80 | 3.84 | — | 8.58 |
| Dipropylene Glycol | 5.82 | 5.82 | 4.87 | 1.58 | — | 7.44 |
| Dye | 0.0203 | 0.0203 | 0.0304 | 0.0288 | 0.0252 | 0.0355 |
| Water and Minors | Balance | Balance | Balance | Balance | Balance | Balance |
| % Air by Volume of | 0-5% | 15 | 21.5 | 30.5 | 5.5 | 44.9 |
| Particle | | | | | | |

### Combinations

A. A packaged composition (160) comprising a plurality of particles (90), wherein said particles comprise:
   polyethylene glycol;
   perfume; and
   a material selected from the group consisting of:
   a polyalkylene polymer of formula H—(C₂H₄O)ₓ—(CH(CH₃)CH₂O)_{y}—(C₂H₄O)_{z}—OH wherein x is from about 50 to about 300, y is from about 20 to about 100, and z is from about 10 to about 200;
   a polyethylene glycol fatty acid ester of formula (C₂H₄O)_{q}—C(O)O—(CH₂)ᵣ—CH₃ wherein q is from about 20 to about 200 and r is from about 10 to about 30;
   a polyethylene glycol fatty alcohol ether of formula HO—(C₂H₄O)ₛ—(CH₂)ₜ)—CH₃ wherein s is from about 30 to about 250 and t is from about 10 to about 30;
   and mixtures thereof;
   wherein each of said particles has a density from about 0.3 g/cm³ to less than 1 g/cm³;
   wherein each of said particles has a mass from about 0.1 mg to about 5 g; and
   wherein each of said particles has a maximum dimension of less than about 10 mm.
B. The packaged composition according to Paragraph A, wherein said particles comprise occlusions of gas.
C. The packaged composition according to Paragraph A or B, wherein each of said particles has a volume and said occlusions of gas within said particle comprise from about 0.5% to about 50% by volume of said particle.
D. The packaged composition according to any of Paragraphs A to C, wherein said particles have a density from about 0.5 g/cm³ to about 0.96 g/cm³.
E. The packaged composition according to any of Paragraphs A to D, wherein said occlusions have an effective diameter from about 1 micron to about 2000 microns.
F. The packaged composition according to any of Paragraphs A to E, wherein said particles comprise from about 20% to about 99% by weight of said particles of polyethylene glycol.
G. The packaged composition according to Paragraph F, wherein said polyethylene glycol has a weight average molecular weight from about 2000 to about 13000.
H. The packaged composition according to any of Paragraphs A to G, wherein said particles comprise from about 15% to about 40% by weight of said particles of said polyalkylene polymer.
I. The packaged composition according to any of Paragraphs A to H, wherein said particles comprise from about 1% to about 20% by weight of said particles said polyethylene glycol fatty acid ester.
J. The packaged composition according to any of Paragraphs A to I, wherein said particles comprise from about 1% to about 10% by weight of said particles said polyethylene glycol fatty alcohol ether.
K. The packaged composition according to any of Paragraphs A to J, wherein said particles comprise from about 0.1% to about 20% by weight of said particles of perfume.
L. The packaged composition according to any of Paragraphs A to K, wherein said perfume comprises encapsulated perfume.
M. The packaged composition according to Paragraphs A to L, wherein said perfume comprises unencapsulated perfume.
N. The packaged composition according to any of Paragraphs A to M, wherein said perfume comprises unencapsulated perfume and encapsulated perfume.
O. The packaged composition according to any of Paragraphs A to N, wherein said particles comprise from about 1% to about 40% by weight of said particles of clay.
P. A process for treating laundry with the packaged composition of any of Claims A to O comprising the step of dosing to a laundry washing machine or a laundry wash basin from about 10 g to about 30 g of said packaged composition.
Q. A process of making the particles of any of Paragraphs A to O comprising the steps of:
   providing a molten carrier material comprising polyethylene glycol and a material selected from the group consisting of: a polyalkylene polymer of formula H—(C₂H₄O)ₓ—(CH(CH₃)CH₂O)_{y}—(C₂H₄O)_{z}—OH wherein x is from about 50 to about 300, y is from about 20 to about 100, and z is from about 10 to about 200; a polyethylene glycol fatty acid ester of formula (C₂H₄O)_{q}—C(O)O—(CH₂)ᵣ—CH₃ wherein q is from about 20 to about 200 and r is from about 10 to about 30; a polyethylene glycol fatty alcohol ether of formula HO—(C₂H₄O)ₛ—(CH₂)ₜ)—CH₃ wherein s is from about 30 to about 250 and t is from about 10 to about 30; and mixtures thereof;
   adding perfume to said molten carrier material;
   entraining a gas into said carrier material; and
   passing said carrier material carrying said perfume and said gas through apertures and
   depositing said carrier material carrying said perfume and said gas onto a conveyor to form said particles.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A packaged composition comprising a plurality of particles (90), wherein said particles comprise:
polyethylene glycol;
perfume; and
a material selected from the group consisting of:
a polyalkylene polymer of formula H—(C₂H₄O)ₓ—(CH(CH₃)CH₂O)_{y}—(C₂H₄O)_{z}—OH wherein x is from about 50 to about 300, y is from about 20 to about 100, and z is from about 10 to about 200;
a polyethylene glycol fatty acid ester of formula (C₂H₄O)_{q}—C(O)O—(CH₂)ᵣ—CH₃ wherein q is from about 20 to about 200 and r is from about 10 to about 30;
a polyethylene glycol fatty alcohol ether of formula HO—(C₂H₄O)ₛ—(CH₂)ₜ)—CH₃ wherein s is from about 30 to about 250 and t is from about 10 to about 30;
and mixtures thereof;
wherein each of said particles has a density from about 0.3 g/cm³ to less than 1 g/cm³;
wherein each of said particles has a mass from about 0.1 mg to about 5 g; and
wherein each of said particles has a maximum dimension of less than about 10 mm.

2. The packaged composition according to claim 1, wherein said particles comprise occlusions of gas.

3. The packaged composition of claim 2, wherein each of said particles has a volume and said occlusions of gas within said particle comprise from about 0.5% to about 50% by volume of said particle.

4. The packaged composition of claim 2, wherein said particles have a density from about 0.5 g/cm³ to about 0.96 g/cm³.

5. The packaged composition of claim 2, wherein said occlusions have an effective diameter from about 1 micron to about 2000 microns.

6. The packaged composition of claim 1, wherein said particles comprise from about 20% to about 99% by weight of said particles of polyethylene glycol.

7. The packaged composition of claim 6, wherein said polyethylene glycol has a weight average molecular weight from about 2000 to about 13000.

8. The packaged composition of claim 1, wherein said particles comprise from about 15% to about 40% by weight of said particles of said polyalkylene polymer.

9. The packaged composition of claim 1, wherein said particles comprise from about 1% to about 20% by weight of said particles said polyethylene glycol fatty acid ester.

10. The packaged composition of claim 1, wherein said particles comprise from about 1% to about 10% by weight of said particles said polyethylene glycol fatty alcohol ether.

11. The packaged composition of claim 1, wherein said particles comprise from about 0.1% to about 20% by weight of said particles of perfume.

12. The packaged composition of claim 11, wherein said perfume comprises encapsulated perfume.

13. The packaged composition of claim 11, wherein said perfume comprises unencapsulated perfume.

14. The packaged composition of claim 11, wherein said perfume comprises unencapsulated perfume and encapsulated perfume.

15. The packaged compositions of claim 11, wherein said particles comprise from about 1% to about 40% by weight of said particles of clay.

16. The packaged composition of claim 1, wherein said particles comprise: polyalkylene polymer of formula H—(C₂H₄O)ₓ—(CH(CH₃)CH₂O)_{y}—(C₂H₄O)_{z}—OH wherein x is from about 50 to about 300, y is from about 20 to about 100, and z is from about 10 to about 200;
polyethylene glycol fatty acid ester of formula (C₂H₄O)_{q}—C(O)O—(CH₂)ᵣ—CH₃ wherein q is from about 20 to about 200 and r is from about 10 to about 30; and
polyethylene glycol fatty alcohol ether of formula HO—(C₂H₄O)ₛ—(CH₂)ₜ)—CH₃ wherein s is from about 30 to about 250 and t is from about 10 to about 30.

17. The packaged composition of claim 15, wherein said particles comprise:
from about 20% to about 99% by weight of said particles of polyethylene glycol having weight average molecular weight from about 2000 to about 13000;
from about 15% to about 40% by weight of said particles of said polyalkylene polymer;
from about 1% to about 20% by weight of said particles said polyethylene glycol fatty acid ester; and
from about 1% to about 10% by weight of said particles said polyethylene glycol fatty alcohol ether.

18. A process for treating laundry with the packaged composition of claim 1 comprising the step of dosing to a laundry washing machine or a laundry wash basin from about 10 g to about 30 g of said packaged composition.

19. A process of making particles comprising the steps of:
providing a molten carrier material comprising polyethylene glycol and a material selected from the group consisting of: a polyalkylene polymer of formula H—(C₂H₄O)ₓ—(CH(CH₃)CH₂O)_{y}—(C₂H₄O)_{z}—OH wherein x is from about 50 to about 300, y is from about 20 to about 100, and z is from about 10 to about 200; a polyethylene glycol fatty acid ester of formula (C₂H₄O)_{q}—C(O)O—(CH₂)ᵣ—CH₃ wherein q is from about 20 to about 200 and r is from about 10 to about 30; a polyethylene glycol fatty alcohol ether of formula HO—(C₂H₄O)ₛ—(CH₂)ₜ)—CH₃ wherein s is from about 30 to about 250 and t is from about 10 to about 30;
and mixtures thereof;
adding perfume to said molten carrier material;
entraining a gas into said carrier material; and
passing said carrier material carrying said perfume and said gas through apertures and
depositing said carrier material carrying said perfume and said gas onto a conveyor to form said particles.
